(19) United States
(12) Patent Application Publication
(10) Pub. No.: US 2013/0106849 A1
(43) Pub. Date: May 2, 2013

(54) IMAGE PROCESSING APPARATUS AND METHOD

(71) Applicant: Samsung Electronics Co., Ltd., Suwon-si (KR)

(72) Inventors: In Woo Ha, Seoul (KR); Tae Hyun Rhee, Yongin-si (KR)

(73) Assignee: Samsung Electronics Co., Ltd., Suwon-si (KR)

(21) Appl. No.: 13/628,664

(22) Filed: Sep. 27, 2012

(30) Foreign Application Priority Data
Nov. 1, 2011 (KR) 10-2011-0112602

(51) Int. Cl. G06T 17/00; G06K 9/40

(52) U.S. Cl. 345/420; 382/260

(57) ABSTRACT

An image processing apparatus is provided. When a depth image is input, an outlier removing unit of the image processing apparatus may analyze depth values of the whole pixels, remove pixels deviating from an average value by at least a predetermined value, and thereby process the pixels as a hole. The input depth image may be regenerated by filling the hole. During the above process, hole filling may be performed using a pull-push scheme.

### CROSS-REFERENCE TO RELATED APPLICATIONS

This application claims the priority benefit of Korean Patent Application No. 10-2011-0112602, filed on Nov. 1, 2011, in the Korean Intellectual Property Office, the disclosure of which is incorporated herein by reference.

### BACKGROUND

1. Field

Embodiments relate to an image processing apparatus and method, and more particularly, to image processing that may be applied during a process of performing a perspective unprojection using a depth image captured from a depth camera.

2. Description of the Related Art

A depth image may be captured from a depth camera using a time of flight (TOF) scheme or a patterned light scheme. The depth image captured from the depth camera may have the perspective projection effect by a view of the depth camera.

For example, a perspective projection may be understood as that when looking up to view an object, for example, a rectangular parallelepiped from a lower place, an upper portion of the object is positioned relatively far and thus, appears small and a lower portion of the object is positioned relatively close and thus, appears large.

Using the depth image, three dimensional (3D) image rendering may be directly performed, or a 3D model for 3D image rendering may be generated. During the above process, a perspective unprojection (perspective projection removal process or perspective projection removal operation) may be used to remove the perspective projection effect.

During the perspective unprojection process, values of u and v that are coordinates in an image may be reversed. Accordingly, there is a desire to configure the depth image as a more reliable 3D model prior to performing the perspective unprojection.

Hole filling and mesh typed mapping of point clouds may have the excellent technical effect during the 3D model configuration process.

### SUMMARY

According to an aspect of one or more embodiments, there is provided an image processing apparatus, including an outlier removing unit to remove an outlier of an input depth image, and a hole filling unit to generate a hole filled depth image by performing hole filling of the outlier removed input depth image using a pull-push scheme.

The pull-push scheme may divide the outlier removed input depth image into a plurality of blocks, calculates a final average value by recursively an average depth value of the blocks using a bottom-up scheme, may recursively apply the final average value using a top-down scheme, and may perform hole filling of the outlier removed input depth image.

The outlier removing unit may remove the outlier of the input depth image by obtaining an average depth value with respect to at least a portion of the input depth image, and by processing, as a hole, a value having at least a predetermined deviation with respect to the average depth value.

The image processing apparatus may further include a filtering unit to perform Gaussian filtering with respect to the hole filled depth image.

The image processing apparatus may further include a mesh generator to generate a mesh based three dimensional (3D) geometry model by configuring, as a mesh, neighboring pixels in the hole filled depth image.

The image processing apparatus may further include a normal calculator to calculate a normal of each of a plurality of meshes that are included in the 3D geometry model. The image processing apparatus may further include a texture coordinator to associate color values of an input color image, which is associated with the input depth image, with the plurality of meshes that are included in the 3D geometry model.

The image processing apparatus may further include an unprojection operation unit to remove a perspective projection at a camera view associated with the input depth image by applying an unprojection matrix to the 3D geometry model.

According to an aspect of one or more embodiments, there is provided an image processing apparatus, including a mesh generator to generate a 3D geometry model associated with an input depth image by generating a single mesh per every three neighboring pixels in the input depth image, a normal calculator to calculate a normal of each of meshes that are included in the 3D geometry model, and a texture coordinator to generate a 3D model about the input depth image and an input color image associated with the input depth image by obtaining texture information of each of the meshes from the input color image.

The image processing apparatus may further include an unprojection operation unit to remove a perspective projection at a camera view associated with at least one of the input depth image and the input color image with respect to the 3D model.

The unprojection operation unit may remove the perspective projection by applying an unprojection matrix to the 3D model.

According to an aspect of one or more embodiments, there is provided an image processing method, including removing an outlier of an input depth image, and generating a hole filled depth image by performing hole filling of the outlier removed input depth image using a pull-push scheme.

The pull-push scheme may divide the outlier removed input depth image into a plurality of blocks, calculates a final average value by recursively an average depth value of the blocks using a bottom-up scheme, may recursively apply the final average value using a top-down scheme, and may perform hole filling of the outlier removed input depth image.

The removing may include removing the outlier of the input depth image by obtaining an average depth value with respect to at least a portion of the input depth image, and by processing, as a hole, a value having at least a predetermined deviation with respect to the average depth value.

According to another aspect of one or more embodiments, there is provided at least one non-transitory computer readable medium storing computer readable instructions to implement methods of one or more embodiments.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an image processing apparatus according to an embodiment;

FIG. 2 illustrates a color image and a depth image input to an image processing apparatus according to an embodiment;

FIG. 3 illustrates a diagram to describe hole filling using a pull-push scheme according to an embodiment;

FIG. 4 illustrates a diagram to describe hole filling using a pull-push scheme according to another embodiment;

FIG. 5 illustrates a hole filled depth image according to an embodiment;

FIG. 6 illustrates a diagram to describe a process of generating a mesh based three dimensional (3D) geometry model using 3D information of a point cloud form according to an embodiment; and

FIG. 7 illustrates an image processing method according to an embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

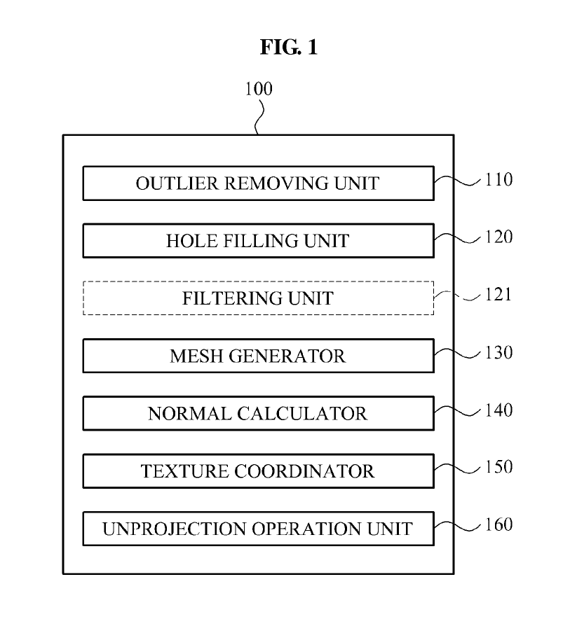

FIG. 1 illustrates an image processing apparatus 100 according to an embodiment.

The image processing apparatus 100 may include an outlier removing unit (outlier remover) 110 to remove noise in an input depth image, for example, to determine, as an outlier, a depth value having a relatively great deviation compared to a neighboring average depth value and thereby remove a corresponding value. During the above process, an artifact, for example, a hole occurring in a depth image, an existing hole becoming larger, and the like, may occur.

A hole filling unit (a hole filler) 120 that may be included in the image processing apparatus 100 may perform image processing such as filling a hole in the depth image.

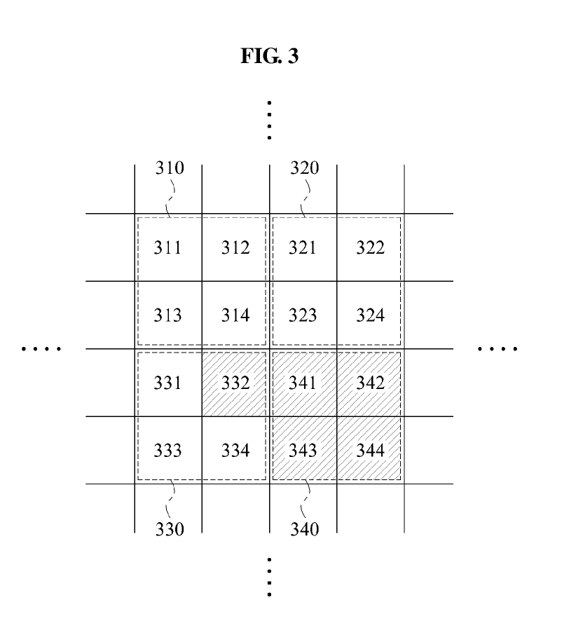

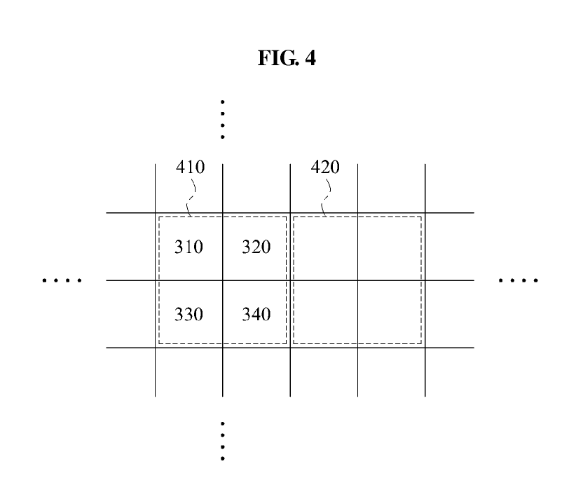

The hole filling unit 120 may remove the hole in the depth image using a pull-push scheme. The pull-push scheme may calculate an average value of the whole depth image by recursively calculating an average depth value using a bottom-up scheme through expansion to an upper group and then may recursively apply the calculated average value again to a lower structure using a top-down scheme, thereby uniformly and quickly removing a hole. The pull-push scheme will be further described with reference to FIG. 3 and FIG. 4.

When the hole filling is completed, a filtering unit (filter) 121 may perform various filtering of removing incompletely removed noise in the hole filled depth image. Such filtering may be understood as smoothing filtering. The filtering unit 121 may enhance the quality of the depth image by performing Gaussian filtering.

A mesh generator 130, a normal calculator 140, and a texture coordinator 150 may generate a three dimensional (3D) model using the depth image.

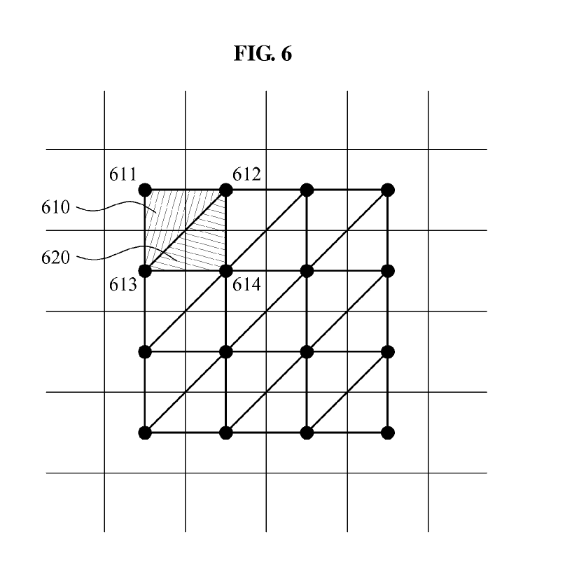

During the above 3D model generation process, the mesh generator 130 may uniformly and regularly generate a mesh by grouping, as a single mesh, neighboring pixels in the depth image. Through the above process, a process of generating a point cloud as mesh based 3D geometry information may be accelerated, which will be further described with reference to FIG. 6.

The normal calculator 140 of the image processing apparatus 100 may calculate a normal of each of meshes, and the texture coordinator 150 may generate a 3D model by associating texture information of an input color image with geometry information, for example, vertices of a mesh. The above process will be further described with reference to FIG. 6.

An unprojection operation unit (projection operation removal unit or projection operation remover) 160 of the image processing apparatus may apply, to the 3D model, an unprojection matrix (projection removal matrix) that is pre-calculated for a perspective unprojection. Accordingly, the 3D model in which the perspective unprojection is performed and that matches an object of real world may be generated. The above process will be further described with reference to FIG. 6.

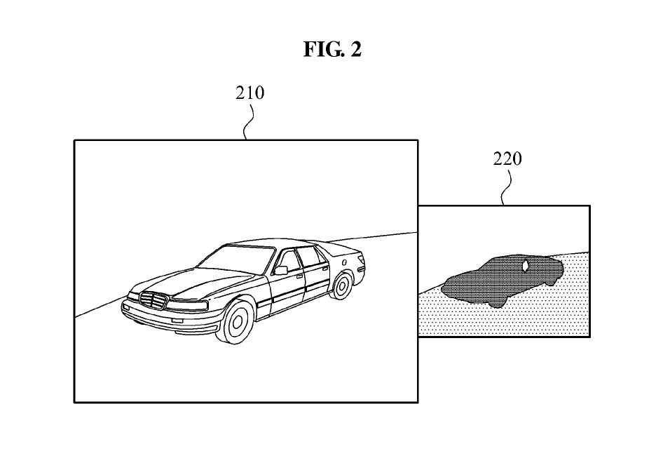

FIG. 2 illustrates a color image 210 and a depth image 220 input to an image processing apparatus according to an embodiment.

The input depth image 220 may have a relatively low resolution compared to the input color image 210. It is assumed that a view of the input depth image 229 matches a view of the input color image 210.

However, even though the same object is photographed, an inconsistency may occur in a photographing view and/or a photographing camera view due to a configuration type of a color camera and a depth camera, a sensor structure, and the like.

Such inconsistency may be overcome by performing various image processing for color-depth image matching in which transformation of camera view difference is reflected. Here, as described above, it is assumed that the input depth image 220 matches the input color image 210 with respect to a camera view.

The input depth image 220 may include a hole due to degradation in a sensor function of the depth camera, depth folding, a noise reduction process, and the like.

The outlier removing unit 110 may remove noise in the input depth image 220, for example, may determine, as an outlier, a depth value having a relatively great deviation compared to a neighboring average depth value and thereby remove a corresponding value.

During the above process, an artifact, for example, a hole occurring in the input depth image 220, an existing hole becoming larger, and the like, may occur.

According to an embodiment, it is possible to generate a 3D model by generating a 3D geometry model using the input depth image 220, and by matching the 3D geometry model and texture information of the input color image 210.

By performing a perspective unprojection and rendering with respect to the 3D model, it is possible to generate a 3D image, for example, a stereoscopic image, a multi-view image, and the like.

The hole filling unit 120 may remove a hole in the input depth image 220 using a pull-push scheme.

The pull-push scheme will be further described with reference to FIG. 3 and FIG. 4.

FIG. 3 illustrates a diagram to describe hole filling using a pull-push scheme according to an embodiment.

Pixels 311, 312, 313, 314, 321, 322, 323, 324, 331, 332, 333, 334, 341, 342, 343, 344, and the like, of a depth image are shown. The pixels 311, 312, 313, 314, 321, 322, 323, 324, 331, 332, 333, 334, 341, 342, 343, 344, and the like, may be a portion of the whole depth image.

Here, the shaded pixels 332, 341, 342, 343, and 344 may be assumed as a hole. For example, the pixels 332, 341, 342, 343, and 344 may correspond to regions that are determined as an outlier and thereby are removed by the outlier removing unit 110 or do not have a depth value for other reasons.

According to another embodiment, when a perspective unprojection process is initially performed for the depth image, a hole occurring during the perspective unprojection process may also be classified as the pixels 332, 341, 342, 343, and 344.

Hereinafter, only a method of processing the pixels 332, 341, 342, 343, and 344 determined as a hole will be described and the reason of generating the hole will not be described. A difference in hole generations according to various embodiments may be understood to belong to the scope of embodiments without departing from the spirits of the embodiments.

The hole filling unit 120 may group every four pixels as a single group and then calculate an average value thereof.

The hole filling unit 120 may group the pixels 311, 312, 313, and 314 as a single group 310, and may group the pixels 321, 322, 323, and 324 as another single group 320. Using the same method, groups 330 and 340 may be generated.

In this example, the group 330 includes the pixel 332 corresponding to the hole that does not have a depth value. All of the pixels 341, 342, 343, and 344 belonging to the group 340 correspond to the hole.

In this example, when calculating the average depth value of the group 330, the average depth value of the pixels 331, 332, and 333 having depth values may be calculated without using the pixel 332 corresponding to the hole. The calculated average depth value may be determined as the average value of the entire group 330.

In the case of a group in which no pixel has a depth value such as the group 340, the group 340 may remain as a hole and the calculated average depth value may not be available.

Using the same method, a recursive average value calculation may be performed with respect to other groups.

For example, the groups 310, 320, 330, and 340 may be grouped as an upper group. The average of the groups 310, 320, 330, and 340 may be determined as an average depth value of the upper group.

FIG. 4 illustrates a diagram to describe hole filling using a pull-push scheme according to another embodiment.

Even though the recursive calculation is performed, the group 340 that is overall a hole and thus does not have a depth value may still remain as a hole. Therefore, when calculating the average of an upper group 410, the average depth value of the groups 310, 320, and 330 may be determined as a depth value of the upper group 410 without using the group 340.

The above process may also be performed with respect to another upper group 420 and the like.

The upper groups 410, 420, and the like may recursively contribute to the average calculation of further upper groups.

When expansion is recursively performed as above, a single value that represents the input depth image 220 may be generated in the conventional art.

A hole may be filled by expansively applying the obtained value with respect to a lower group again.

For example, when a depth value of an upper group of the group 330 of FIG. 3 is V_330, a depth value V_332 of the pixel 332 enabling the entire average to be V_330 may be calculated in comparison with V_331, V_333, and V_334 that are depth values of the pixels 331, 333, and 334.

As described above, the hole filling unit 120 of the image processing apparatus 100 may calculate an average value of the entire depth image by recursively expanding and thereby calculating an average depth value using a bottom-up scheme and then apply the calculated average value to a lower structure again using a top-down scheme, thereby uniformly and quickly removing a hole.

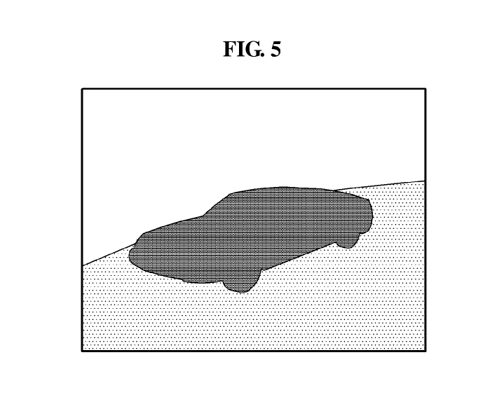

FIG. 5 shows an image of which hole filling is completed using the above scheme.

FIG. 5 illustrates a hole filled depth image according to an embodiment.

Referring to FIG. 5, it can be seen that the hole present in the input depth image 220 of FIG. 2 is removed and a further natural depth image is generated.

According to an embodiment, the image processing apparatus 100 may perform smoothing filtering to remove incompletely removed noise in the hole filled depth image.

For example, the filtering unit 121 may enhance the quality of depth image by performing Gaussian filtering.

When hole filling and selective filtering of the depth image is performed, generation of a 3D model using the depth image may be performed.

FIG. 6 illustrates a diagram to describe a process of generating a mesh based 3D geometry model using 3D information of a point cloud form according to an embodiment.

Geometry information completed using a depth image may be understood as a point cloud form. For example, the geometry information may be understood as 3D vectors in which a depth value z is added to indices u and v of X axis and Y axis of the depth image.

A mesh based 3D model may be further preferred during an image processing or rendering process. The mesh generator 10 of the image processing apparatus 100 may construct mesh based 3D geometry information using point clouds of the depth image that is hole filled or selective smoothing filtered using the above processes.

In general, a point cloud may be a set of points that are represented as a significantly large number of 3D vectors. Accordingly, a process of associating points in order to generate the mesh based 3D geometry information may have very various selections.

Various researches on a method of grouping points as a single mesh have been conducted.

According to an embodiment, a depth image may be captured from an object maintaining a continuity. Therefore, based on presumption that a neighboring pixel within the depth image may be highly probably associated with a neighboring point even in an actual object, neighboring pixels in the depth image may be uniformly grouped to thereby generate meshes.

For example, pixels 611, 612, and 613 are positioned at neighboring positions within the depth image and thus, may be grouped to generate a single mesh 610.

Similarly, pixels 612, 613 and 614 may be grouped to generate a mesh 620.

A process of generating a point cloud as mesh based 3D geometry information may be significantly accelerated by uniformly and regularly generating a mesh.

The normal calculator 140 of the image processing apparatus 100 may simply calculate a normal of the mesh 610 by calculating an outer product of three vectors u, v, and z corresponding to the pixels 612, 613, and 614, respectively.

The normal may be calculated as above. The texture coordinator 150 of the image processing apparatus 100 may match texture information, for example, color information, and the like, between the depth image and a color image.

When a resolution of the depth image is different from a resolution of the color image, up-scaling may be performed during the above process.

A 3D model for rendering of a 3D image may be constructed through the above process.

The unprojection operation unit 160 of the image processing apparatus 100 may apply, to the constructed 3D model, an unprojection matrix that is pre-calculated for a perspective unprojection. Accordingly, the 3D model in which the perspective unprojection is performed and that matches an object of real world may be generated.

Next, the 3D image may be generated through rendering, for example, height field ray-tracing, and the like.

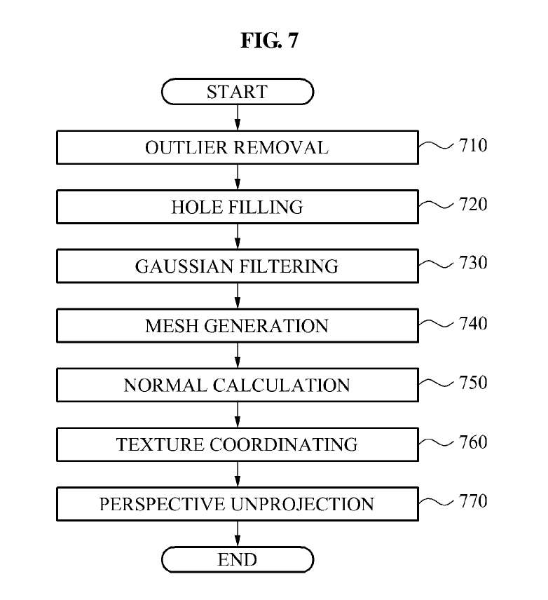

FIG. 7 illustrates an image processing method according to an embodiment.

In operation 710, a depth value having a relatively great deviation compared to a neighboring average depth value within an input depth image may be determined as an outlier and thereby be removed.

In operation 720, a hole occurring or becoming larger during the above process may be removed by performing a hole filling process.

The hole filling process may be performed by the hole filling unit 120 of FIG. 1 that may remove a hole using a pull-push scheme. Hole removal using the pull-push scheme is described above with reference to FIG. 2 through FIG. 4.

In operation 730, the quality of depth image may be enhanced by selectively performing Gaussian filtering.

In operation 740, the mesh generator 130 of the image processing apparatus 100 may uniformly and regularly generate a mesh by grouping, as a single mesh, neighboring pixels in the depth image. The above process is described above with reference to FIG. 6.

In operation 750, the normal calculator 140 of the image processing apparatus 100 may calculate a normal of each mesh. In operation 760, the texture coordinator 150 may generate a 3D model by associating texture information of an input color image with geometry information, for example, vertices of a mesh.

In operation 770, the unprojection operation unit 160 of the image processing apparatus 100 may apply, to the constructed 3D model, an unprojection matrix that is pre-calculated for a perspective unprojection. The above processes are described above with reference to FIG. 6 and thus, further description will be omitted here.

The image processing method according to the above-described embodiments may be recorded in non-transitory computer-readable media storing program instructions (computer-readable instructions) to implement various operations by executing program instruction to control one or more processors, which are part of a computer, a computing device, a computer system, or a network. The non-transitory computer-readable media may also be embodied in at least one application specific integrated circuit (ASIC) or Field Programmable Gate Array (FPGA), which executes (processes like a processor) computer readable instructions. The media may also store, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Another example of non-transitory computer-readable media may also be non-transitory computer-readable media in a distributed network, so that the computer readable instructions are stored and executed in a distributed fashion.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image processing apparatus, comprising:
an outlier remover to remove an outlier of an input depth image; and
a hole filler to generate a hole filled depth image by performing hole filling of the outlier removed input depth image using a pull-push scheme using at least one processor.

2. The image processing apparatus of claim 1, wherein the pull-push scheme divides the outlier removed input depth image into a plurality of blocks, calculates a final average value by recursively an average depth value of the blocks using a bottom-up scheme, recursively applies the final average value using a top-down scheme, and performs hole filling of the outlier removed input depth image.

3. The image processing apparatus of claim 1, wherein the outlier remover removes the outlier of the input depth image by obtaining an average depth value with respect to at least a portion of the input depth image, and by processing, as a hole, a value having at least a predetermined deviation with respect to the average depth value.

4. The image processing apparatus of claim 1, further comprising:
a filter to perform Gaussian filtering with respect to the hole filled depth image.

5. The image processing apparatus of claim 1, further comprising:
a mesh generator to generate a mesh based three dimensional (3D) geometric model by configuring, as a mesh, neighboring pixels in the hole filled depth image.

6. The image processing apparatus of claim 5, further comprising:
a normal calculator to calculate a normal of each of a plurality of meshes that are included in the 3D geometric model.

7. The image processing apparatus of claim 6, further comprising:
a texture coordinator to associate color values of an input color image, which is associated with the input depth image, with the plurality of meshes that are included in the 3D geometric model.

8. The image processing apparatus of claim 5, further comprising:
a projection operation remover to remove a perspective projection at a camera view associated with the input depth image by applying a projection removal matrix to the 3D geometry model.

9. An image processing apparatus, comprising:
a mesh generator to generate a three dimensional (3D) geometric model associated with an input depth image by generating a single mesh per every three neighboring pixels in the input depth image;
a normal calculator to calculate a normal of each of meshes that are included in the 3D geometric model using at least one processor; and
a texture coordinator to generate a 3D model about the input depth image and an input color image associated with the input depth image by obtaining texture information of each of the meshes from the input color image.

10. The image processing apparatus of claim 9, further comprising:
a projection operation remover to remove a perspective projection at a camera view associated with at least one of the input depth image and the input color image with respect to the 3D model.

11. The image processing apparatus of claim 10, wherein the projection operation remover removes the perspective projection by applying a projection removal matrix to the 3D model.

12. An image processing method, comprising:
removing an outlier of an input depth image; and
generating a hole filled depth image by performing hole filling of the outlier removed input depth image using a pull-push scheme using at least one processor.

13. The method of claim 12, wherein the pull-push scheme divides the outlier removed input depth image into a plurality of blocks, calculates a final average value by recursively an average depth value of the blocks using a bottom-up scheme, recursively applies the final average value using a top-down scheme, and performs hole filling of the outlier removed input depth image.

14. The method of claim 12, wherein the removing comprises removing the outlier of the input depth image by obtaining an average depth value with respect to at least a portion of the input depth image, and by processing, as a hole, a value having at least a predetermined deviation with respect to the average depth value.

15. The method of claim 12, further comprising:
performing Gaussian filtering with respect to the hole filled depth image.

16. The method of claim 12, further comprising:
generating a mesh based three dimensional (3D) geometric model by configuring, as a mesh, neighboring pixels in the hole filled depth image.

17. The method of claim 16, further comprising:
calculating a normal of each of a plurality of meshes that are included in the 3D geometric model.

18. The method of claim 17, further comprising:
associating color values of an input color image, which is associated with the input depth image, with the plurality of meshes that are included in the 3D geometric model.

19. The method of claim 16, further comprising:
removing a perspective projection at a camera view associated with the input depth image by applying a projection removal matrix to the 3D geometry model.

20. At least one non-transitory computer-readable medium storing computer-readable instructions that control at least one processor to perform an image processing method, the method comprising:
removing an outlier of an input depth image; and
generating a hole filled depth image by performing hole filling of the outlier removed input depth image using a pull-push scheme using at least one processor.

21. The image processing apparatus of claim 1, wherein the projection operation unit remover removes the perspective projection by applying a projection removal matrix to the 3D model.

22. The image processing apparatus of claim 1, further comprising a mesh generator to generate a mesh based three dimensional (3D) geometric model using 3D information of a point of cloud form.

23. An image processing apparatus, comprising:
a hole filler to generate a hole filled depth image by performing hole filling of each outlier removed from an input depth image using at least one processor; and
a mesh generator to generate a mesh based three dimensional (3D) geometric model by configuring, as a mesh, neighboring pixels in the hole filled depth image.

24. The image processing apparatus of claim 23, further comprising:
a projection operation remover to remove a perspective projection at a camera view associated with the input depth image by applying a projection removal matrix to the 3D geometry model.
